(19) United States
(12) Patent Application Publication
(10) Pub. No.: US 2024/0128576 A1
(43) Pub. Date: Apr. 18, 2024

(54) Lock for a rechargeable battery

(71) Applicant: Hilti Aktiengesellschaft, Schaan (LI)

(72) Inventor: Manfred JAKOB, Kaufering (DE)

(21) Appl. No.: 18/277,388

(22) PCT Filed: Feb. 22, 2022
(86) PCT No.: PCT/EP22/54353

§ 371 Date: Aug. 16, 2023

(30) Foreign Application Priority Data
Mar. 3, 2021 (EP) 21160449.1

(51) Int. Cl. H01M 50/264; H01M 50/213

(52) U.S. Cl. CPC H01M 50/264; H01M 50/213; H01M 2220/30

(57) ABSTRACT

Rechargeable battery for supplying a power tool with electrical energy. The rechargeable battery includes a locking apparatus for releasably connecting the rechargeable battery to the power tool, wherein the locking apparatus includes at least one first and second lever element that are connected together in an articulated manner, such that the locking apparatus is reversibly movable from a locking position into a releasing position, wherein, in the locking position, the rechargeable battery is firmly connected to the power tool and, in the releasing position, the rechargeable battery is removable from the power tool.

The present invention relates to a system comprising a power tool and a rechargeable battery for supplying the power tool with electrical energy.

Furthermore, the present invention relates to a rechargeable battery for supplying a power tool with electrical energy.

### BACKGROUND

Systems consisting of a power tool and a rechargeable battery as energy supply are very widely known from the prior art. Furthermore, rechargeable batteries for supplying a power tool with electrical energy are also very widely known from the prior art.

Usually, a rechargeable battery for supplying the power tool with electrical energy is releasably connected to the power tool via an interface. The interface has mechanical and electrical components. The mechanical components serve to mechanically attach the rechargeable battery to the power tool in the form of a form-fitting connection. The electrical components serve to transmit the electrical energy from the rechargeable battery to the power tool. The mechanical components are often a rail system with which the rechargeable battery can be pushed onto the power tool. The electrical components are usually configured as plug contacts, i.e. a plug and socket, such that a plug on the rechargeable battery can be plugged into a corresponding socket on the power tool. When the rechargeable battery is pushed onto the power tool with the aid of the rails, the plugs of the rechargeable battery are connected to the sockets of the power tool.

### SUMMARY OF THE INVENTION

During the use of a power tool with a connected rechargeable battery, significant mechanical stresses in the form of vibrations or impacts can occur. In particular when the power tool is configured as a hammer drill or chipping hammer, relatively strong vibrations can occur in most applications. Since the power tool and the rechargeable battery have different masses, the power tool and the rechargeable battery vibrate differently than one another. This results in a relative movement between the power tool and the rechargeable battery such that both the mechanical and the electrical connecting components at the interface between the power tool and the rechargeable battery can be damaged. In particular, the plug-socket connection of the rechargeable battery to the power tool is sensitive to these relative movements or to vibrations.

An object of the present invention is to provide a system comprising a power tool and a rechargeable battery for supplying the power tool with electrical energy, and a rechargeable battery for supplying a power tool with electrical energy, which solves at least the abovementioned problem.

The present invention provides a system comprising a power tool and a rechargeable battery for supplying the power tool with electrical energy.

According to the invention, it is provided that the rechargeable battery comprises a locking apparatus for releasably connecting the rechargeable battery to the power tool, wherein the locking apparatus comprises at least one first and second lever element that are connected together in an articulated manner, such that the locking apparatus is reversibly movable from a locking position into a releasing position, wherein, in the locking position, the rechargeable battery is firmly connected to the power tool and, in the releasing position, the rechargeable battery is removable from the power tool.

As a result, a better connection between the power tool and the rechargeable battery in the assembled state can be achieved, such that a relative movement between the power tool and the rechargeable battery is reduced. In other words: play between the power tool and the rechargeable battery can be eliminated.

The second lever element can be configured in an elastic manner. As a result, a preload can be generated in the locking apparatus.

According to an advantageous embodiment of the present invention, it may be possible for the rechargeable battery to comprise a third lever element for reversibly actuating the second lever element from a first position into a second position.

This can make it easier to handle the locking apparatus for releasably connecting the rechargeable battery to the power tool.

According to an advantageous embodiment of the present invention, it may be possible for the second lever element to be configured at least partially in an elastic manner.

As a result, a preload can be generated by the locking apparatus for a higher contact pressure of the rechargeable battery on the power tool.

According to an advantageous embodiment of the present invention, it may be possible for the locking apparatus to be configured as a toggle mechanism.

As a result, the locking apparatus can also be realized in a simple manner.

According to an advantageous embodiment of the present invention, it may be possible for at least one elastic stop element to be present between the rechargeable battery and power tool, wherein the at least one elastic stop element is positioned opposite the locking apparatus.

Furthermore, the present invention provides a rechargeable battery for supplying a power tool with electrical energy.

According to the invention, it is provided that the rechargeable battery comprises a locking apparatus for releasably connecting the rechargeable battery to the power tool, wherein the locking apparatus comprises at least one first and second lever element that are connected together in an articulated manner, such that the locking apparatus is reversibly movable from a locking position into a releasing position, wherein, in the locking position, the rechargeable battery is firmly connected to the power tool and, in the releasing position, the rechargeable battery is removable from the power tool.

As a result, a better connection between the power tool and the rechargeable battery in the assembled state can be achieved, such that a relative movement between the power tool and the rechargeable battery is reduced. In other words: play between the power tool and the rechargeable battery can be eliminated.

### BRIEF DESCRIPTION OF THE DRAWINGS

Further advantages will become apparent from the following description of the figures. Various exemplary embodiments of the present invention are illustrated in the figures.

The figures, the description and the claims contain numerous features in combination. A person skilled in the art will expediently also consider the features individually and combine them to produce useful further combinations.

In the figures:

FIG. 1 shows a perspective rear view of a power tool with a rechargeable battery in an assembled state;

FIG. 2 shows a perspective rear view of the power tool with the rechargeable battery in a disassembled state;

FIG. 3a shows a perspective detail view of a rechargeable battery interface of the power tool;

FIG. 3b shows a perspective sectional view of the rechargeable battery interface of the power tool;

FIG. 4 shows a sectional side view of the rechargeable battery with the locking apparatus in a first state;

FIG. 5 shows a perspective view of the rechargeable battery with the locking apparatus in the first state;

FIG. 6 shows a sectional side view of the rechargeable battery with the locking apparatus in a second state;

FIG. 7 shows a perspective view of the rechargeable battery with the locking apparatus in the second state;

FIG. 8 shows a sectional side view of the rechargeable battery with the locking apparatus in a third state;

FIG. 9 shows a perspective view of the rechargeable battery with the locking apparatus in the third state;

FIG. 10 shows a sectional side view of the rechargeable battery with the locking apparatus in a fourth state;

FIG. 11 shows a perspective view of the rechargeable battery with the locking apparatus in the fourth state;

FIG. 12 shows a sectional side view of the rechargeable battery with the locking apparatus in a fifth state; and

FIG. 13 shows a perspective view of the rechargeable battery with the locking apparatus in the fifth state.

### DETAILED DESCRIPTION

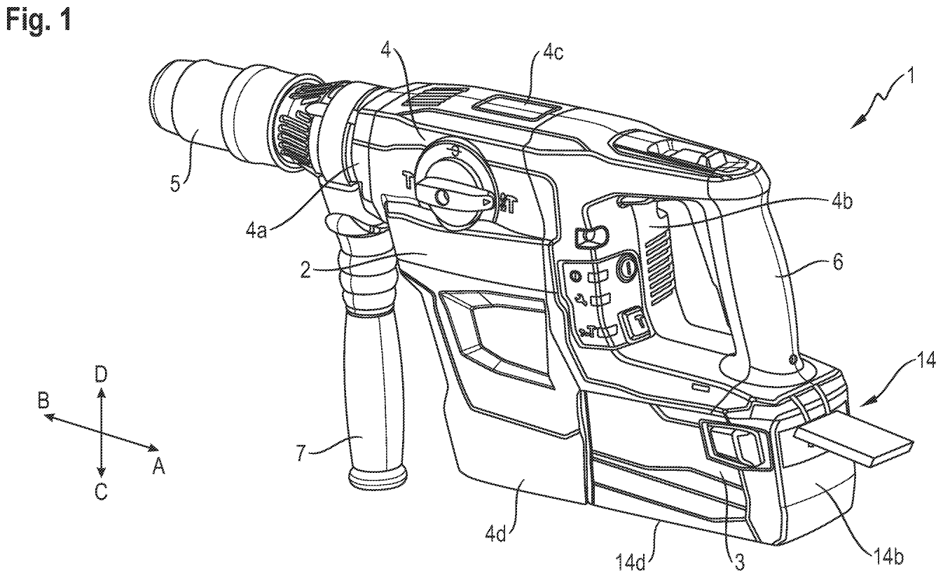

FIG. 1 shows a system 1 comprising a power tool 2 and a rechargeable battery 3 in a first state, wherein the rechargeable battery 3 is connected to the power tool 2. The rechargeable battery 3 serves to supply the power tool 2 with electrical energy.

The rechargeable battery 3 may also be referred to as a power pack or a battery.

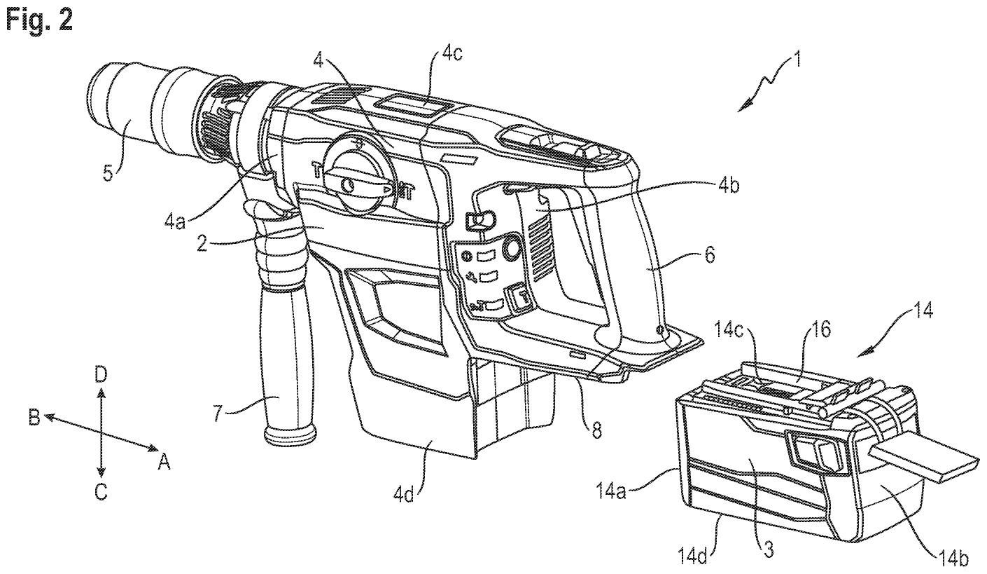

In FIG. 2, the power tool 2 and the rechargeable battery 3 are shown in a second state, wherein the rechargeable battery has been removed or pulled off the power tool 2 in the direction A.

The power tool 2 is configured for example in the form of a hammer drill. Alternatively, the power tool 2 may be configured in the form of a grinder, a saw, a chipping hammer or the like.

The power tool 2 in FIG. 1 substantially comprises a housing 4, a tool fitting 5, a main handle 6, an auxiliary handle 7 and a rechargeable battery interface 8.

The housing 4 of the power tool 2 has a front end 4a, a rear end 4b, a top side 4c and an underside 4d.

Positioned in the interior of the housing 4 of the power tool 2 is a drive in the form of an electric motor, a transmission, an impact mechanism and a control device.

The tool fitting 5 is positioned at the front end 4a of the housing 4 of the power tool 2 and serves for receiving and holding a tool. In the present exemplary embodiment, in which the power tool 2 is configured as a hammer drill, the tool is a drill bit.

The main handle 6 is positioned at the rear end 4b of the housing 4 of the power tool 2 and is used by a user to hold and guide the power tool 2.

The auxiliary handle 7 is likewise positioned at the front end 4a of the housing 4 of the power tool 2 and is used by a user to hold and guide the power tool 2 in addition to the main handle 6. As is apparent from FIGS. 1 and 2, the auxiliary handle 7 is arranged in front of the tool fitting 5 in the arrow direction A. The auxiliary handle 7 is releasably connected to the housing 4 of the power tool 2.

As is likewise apparent from FIGS. 1 and 2, a rechargeable battery interface 8 is positioned at the rear end 4b of the housing 4 of the power tool 2. The rechargeable battery interface 8 is arranged beneath the main handle 6 in the arrow direction C and serves to receive and hold the rechargeable battery 3.

The rechargeable battery interface 8 substantially comprises a mechanical connection device and an electrical connection device. The mechanical connection device serves, on the power tool side, to attach the rechargeable battery 3 to the power tool 2 in a form-fitting manner. By contrast, the electrical connection device serves, on the power tool side, to electrically attach the rechargeable battery 3 to the power tool 2 such that electrical energy can pass from the rechargeable battery 3 to the power tool 2.

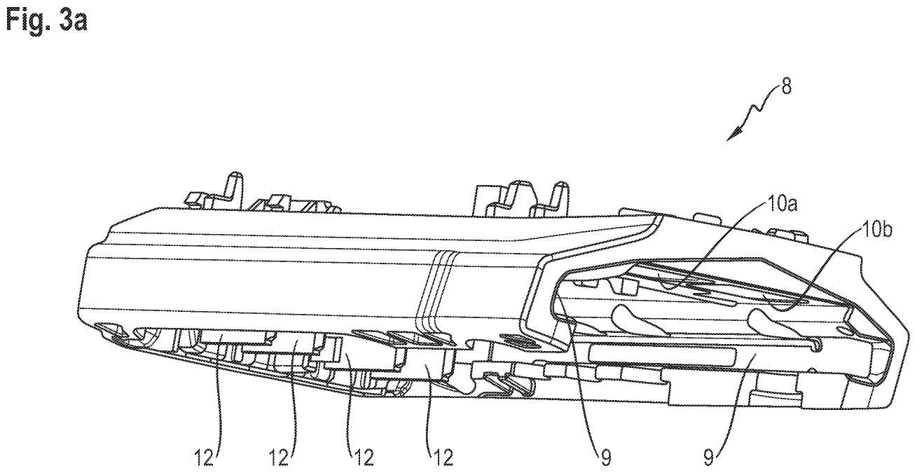

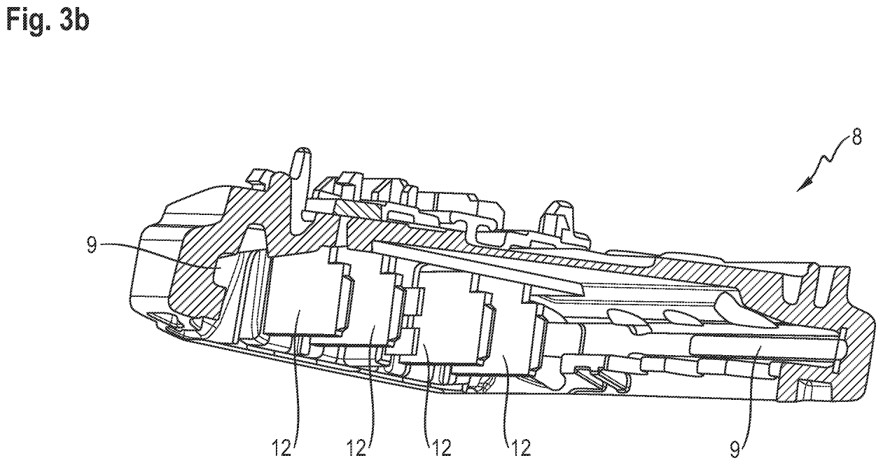

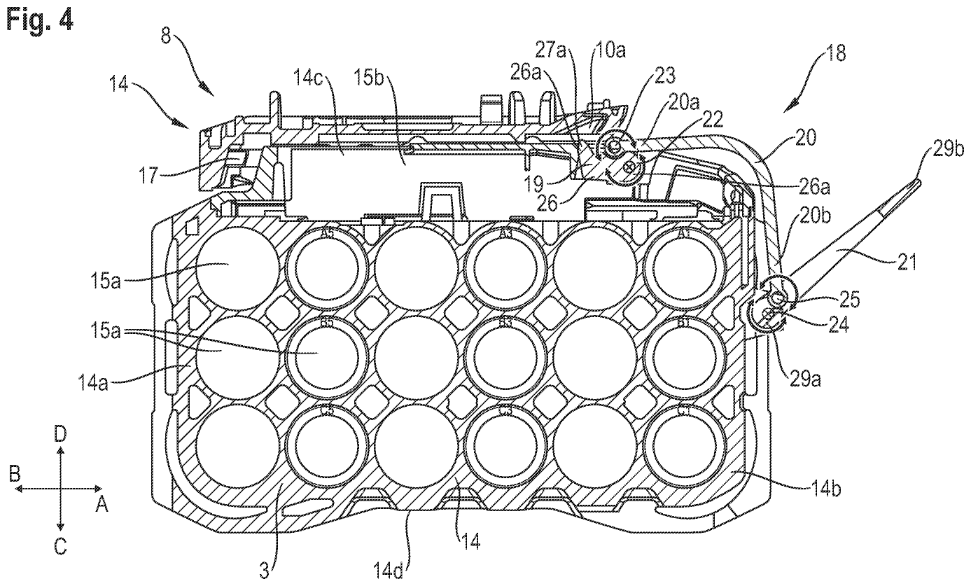

As indicated in FIGS. 3a and 3b, the mechanical connection device is configured substantially in the form of two slots 9 and a first and second recess 10a, 10b. The slots 9 can also be referred to as grooves or furrows. As is described below, the slots 9 serve to receive corresponding rails on the rechargeable battery 3. The first and second recesses 10a, 10b serve to receive a lever element of the rechargeable battery 3 such that a form-fitting and force-fitting connection can be formed between the rechargeable battery 3 and the power tool 2. As shown in FIG. 4, the first recess 10a (and thus likewise second recess 10b) have substantially a triangular cross-sectional area with a certain undercut in the arrow direction A.

As likewise indicated in FIGS. 3a and 3b, the electrical connection device is configured substantially by four plugs 12. The four plugs 12 serve to be plugged into corresponding sockets on the rechargeable battery 3, with the result that an electrical connection is established between the rechargeable battery 3 and the power tool 2.

As shown in the figures, the rechargeable battery 3 contains a rechargeable battery housing 14 with a front side 14a, a rear side 14b, a top side 14c and an underside 14d (see, e.g., FIG. 4).

Positioned in the interior of the rechargeable battery housing 14 are a multiplicity of energy storage cells 15a and a control device 15b. The energy storage cells 15a serve to receive, store and output electrical energy. In the present exemplary embodiment, the energy storage cells 15a are based on lithium-ion technology.

Positioned on the top side 14c of the rechargeable battery housing 14 is a power tool interface 16. The power tool interface 16 likewise substantially comprises a mechanical connection device and an electrical connection device. The mechanical connection device serves, on the rechargeable battery side, to attach the rechargeable battery 3 to the power tool 2 in a form-fitting manner. By contrast, the electrical connection device serves, on the rechargeable battery side, to electrically attach the rechargeable battery 3 to the power tool 2 such that electrical energy can pass from the rechargeable battery 3 to the power tool 2. The electrical connection device is arranged on the top side 14c and in the vicinity of the front side 14a of the rechargeable battery housing 14.

As indicated in the figures, in particular in FIG. 2, the mechanical connection device is configured substantially in the form of the two rails. The rails are designed here such that they can be received in the corresponding slots 9 of the rechargeable battery interface 8 on the power tool 2.

As indicated in FIG. 2, the electrical connection device of the power tool interface 16 of the rechargeable battery 3 is configured substantially by four sockets 13. The four sockets serve to receive the corresponding plugs on the mechanical connection device of the rechargeable battery interface 8 of the power tool 2, with the result that an electrical connection is established between the rechargeable battery 3 and the power tool 2.

Furthermore, an elastic stop element 17 (see, e.g., FIG. 4) is provided at the rechargeable battery interface 8 of the power tool 2. As is most clearly apparent from FIG. 4, the elastic stop element 17 is positioned such that it can exert its elastic spring force between the power tool interface 16 and the rechargeable battery interface 8.

As is likewise apparent from the figures, including FIG. 4, the rechargeable battery 3 furthermore comprises a locking apparatus 18. The locking apparatus 18 serves for releasably connecting the rechargeable battery 3 to the power tool 2 and extends from the top side 14c to the rear side 14b of the rechargeable battery housing 14.

The locking element 18 substantially comprises a first lever element 19, a second lever element 20, a third lever element 21, a first rotary joint 22, a second rotary joint 23, a third rotary joint 24 and a fourth rotary joint 25.

The first lever element 19 comprises an elongate basic body 26 with a first end 26a and a second end 26b. The first lever element 19 can be referred to as locking element. The first end 26a of the basic body 26 is positioned rotatably on the top side 14c of the rechargeable battery housing 14 by means of the first rotary joint 22. Provided at the second end 26b of the basic body 26 is a first and a second hook element 27a, 27b, which each extend substantially at an obtuse angle to a longitudinal orientation of the basic body 26. The first and second hook elements 27a, 27b are designed to be introduced into the corresponding recesses in the rechargeable battery interface 8 of the power tool 2. The shape of the hook elements 27a, 27b corresponds substantially to the shape of the recesses 10a, 10b.

Furthermore, the second rotary joint 23 is present at the first end 26a of the basic body 26. The second rotary joint 23 is positioned obliquely above the first rotary joint 22 in the arrow direction D. As described in even more detail below, the first and second rotary joint 22, 23 are arranged with respect to one another such that, as a result of the first lever element 19 being rotated about a pivot point of the second rotary joint 23, a concentric rotary movement of the first lever element 19 takes place.

The second lever element 20 substantially comprises a curved basic body 28. The second lever element 20 can be referred to as connecting element. The second lever element 20 connects the first lever element 19 to the third lever element 21. The curved basic body 28 can also be referred to as arcuate basic body. The curved basic body 28 is configured such that the second lever element 20 has a certain spring function or spring action. To this end, the curved basic body 28 has a length-to-thickness ratio and is made from a material such that the second lever element 20 has a certain flexibility or elasticity. As is apparent from the figures, the contour of the curved basic body 28 substantially follows a curved transition from the top side 14c to the rear side 14b of the rechargeable battery housing 14. The curved transition from the top side 14c to the rear side 14b of the rechargeable battery housing 14 can also be referred to as an arc, rounded side edge or rounding. The curved basic body 28 is configured in this way in order to be applied to the top side 14c and rear side 14b of the rechargeable battery housing 14 in a space-saving manner.

A first end 20a of the second lever element 20 is rotatably connected to the first lever element 19 by the second rotary joint 23 such that the first lever element 19 and the second lever element 20 can be pivoted relative to one another about the pivot point of the second rotary joint 23.

Provided at the second end 20b of the second lever element 20 is the third rotary joint 24.

The third lever element 21 has a flat elongate basic body 29, which comprises a first end 29a and a second end 29b. The third lever element 21 can also be referred to as operating element. The third lever element 21 configured as an operating element is used by a user of the locking apparatus 18 as an activating element in order to operate the locking apparatus 18.

According to an alternative embodiment, the locking apparatus 18 can also be configured without the third lever element 21. In this embodiment of the locking apparatus 18, the second lever element 20 serves as an activating element, with which a user can operate the locking apparatus 18. The first end 29a of the third lever element 21 is connected to the rear side 14b of the rechargeable battery housing 14 by the third rotary joint 24 such that the third lever element 21 can be pivoted or rotated about the third rotary joint 24 relative to the rechargeable battery housing 14. The fourth rotary joint 25 is positioned in the vicinity of the first end 29a of the third lever element 21. As is apparent from FIG. 4, the fourth rotary joint 25 is arranged above the third rotary joint 24 in the arrow direction D. The second end 20b of the second lever element 20 is rotatably connected to the first end 29a of the third lever element 21 by the fourth rotary joint 25 such that the second lever element 20 and the third lever element 21 can be pivoted or rotated relative to one another.

As already mentioned above, the locking apparatus 18 serves for releasably connecting the rechargeable battery 3 to the power tool 2. To this end, the locking apparatus 18 can be moved reversibly from a locking position into a releasing position. In the locking position, the power tool interface 16 of the rechargeable battery 3 is connected relatively firmly to the rechargeable battery interface 8 of the power tool 2 with the aid of the locking apparatus 18. The connection is at least firm enough that even vibrations that arise during the use of the power tool 2 do not result in a relative movement between the power tool 2 and the connected rechargeable battery 3.

The functioning of the locking apparatus 18 is primarily shown in FIGS. 4 to 13. In particular, FIGS. 4 to 13 show how the locking apparatus 18 is moved from a releasing position into a locking position. In the locking position, the rechargeable battery 3 and the power tool 2 are connected together (cf. FIG. 1) and in the releasing position, the rechargeable battery 3 and the power tool 2 can be separated from one another (cf. FIG. 2).

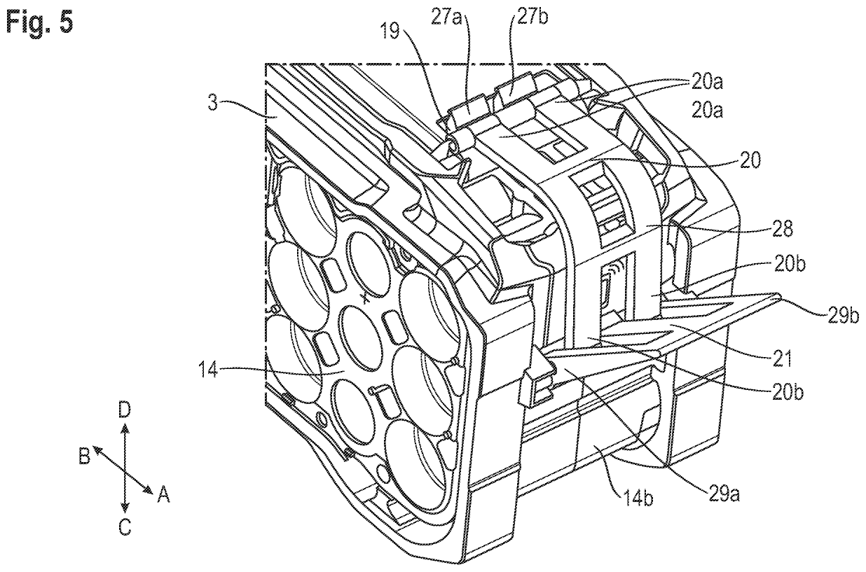

In FIGS. 4 and 5, the rechargeable battery 3 is illustrated with the locking apparatus 18 in a first position. The first position is a releasing position, in which the rechargeable battery 3 can be removed from the power tool 2 or pulled off the power tool 2 in the arrow direction A. The rechargeable battery 3 is not connected to the power tool 2 in a form-fitting or force-fitting manner in the releasing position. The second end 29b of the third lever element 21 has been moved as far as possible in the arrow direction D and is thus in the highest position. As is apparent from FIG. 4, the elastic stop element 17 has not yet been compressed or is still relaxed, and so no spring force, or only a minimum spring force, is exerted on the rechargeable battery 3 by the elastic stop element 17.

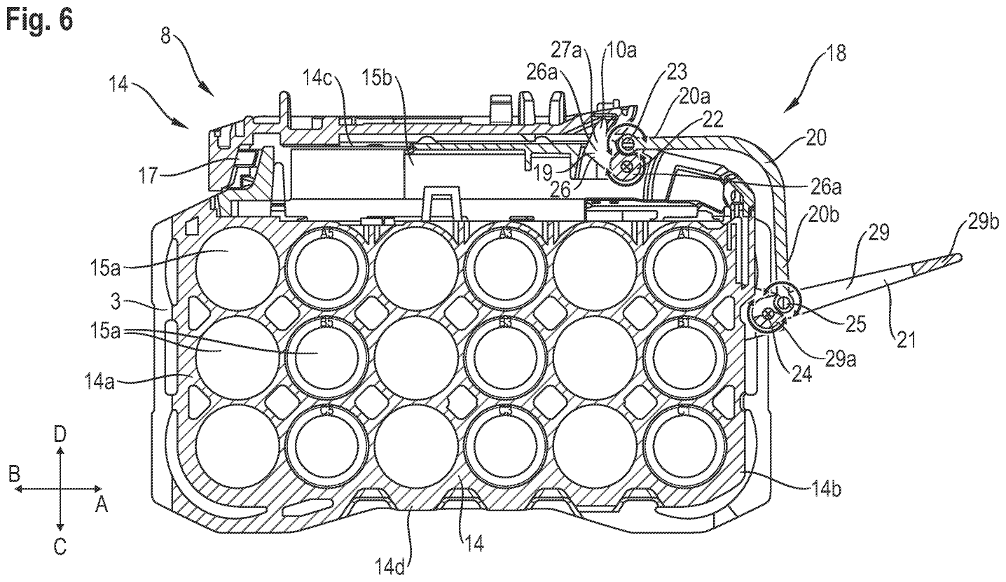

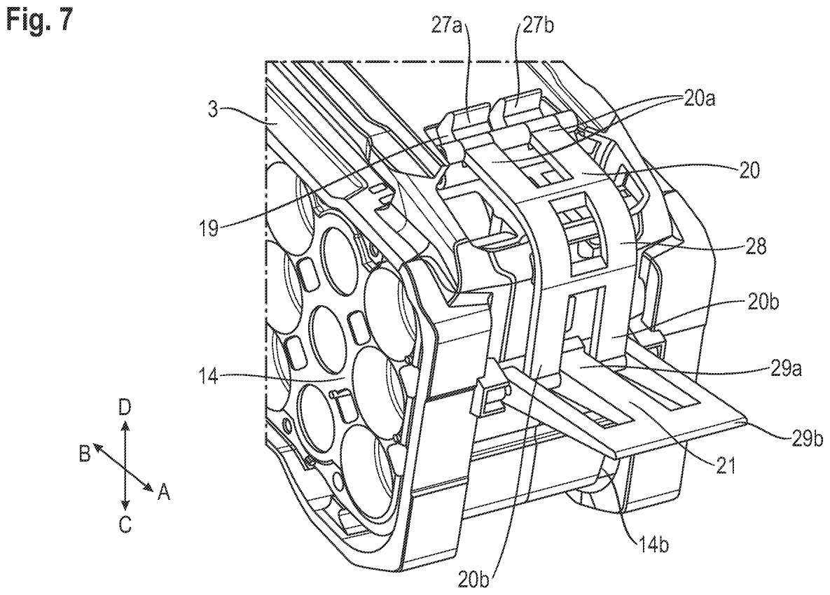

In FIGS. 6 and 7, the rechargeable battery 3 is illustrated with the locking apparatus 18 in a second position. The second end 29b of the third lever element 21 has been moved (i.e. pushed) a certain distance downward in the arrow direction C. The first end 29a of the third lever element 21 rotates about the pivot point of the third rotary joint 24 relative to the rear side 14b of the rechargeable battery housing 14.

The first end 20a of the second lever element 20 moves in the arrow direction A and the first lever element 19 rotates about the pivot point of the first rotary joint 22. The second rotary joint 23 serves to compensate for the relative movement of the first lever element 19 and second lever element 20, since the first lever element 19 rotates concentrically about the pivot point of the second rotary joint 23. As is apparent from FIG. 6, the first and second hook element move in the arrow direction D as a result of the rotary movement of the first lever element and engage in the two recesses 10a, 10b of the rechargeable battery interface 8 of the power tool 2. At the same time, the second end 20b of the second lever element 20 moves in the arrow direction C. As a result of the rotation of the third lever element 21 about the pivot point of the third rotary joint 24, the fourth rotary joint 25 rotates concentrically about the pivot point of the third rotary joint 24.

As is apparent from FIG. 6, the rechargeable battery 3 is moved in the arrow direction B by the movement of the locking apparatus 18 such that the elastic stop element 17 is now compressed. A certain spring force from the elastic stop element 17 acts on the rechargeable battery 3.

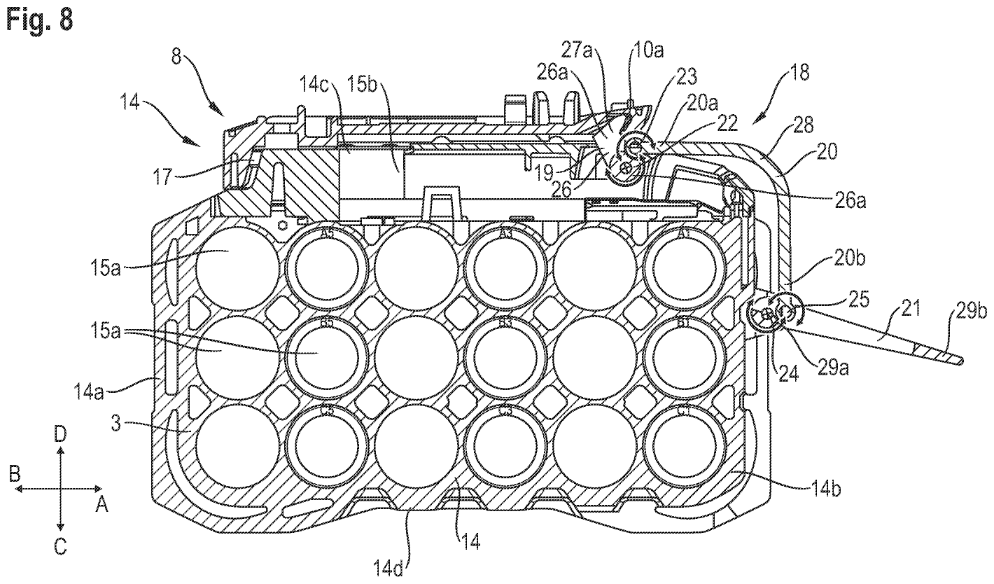

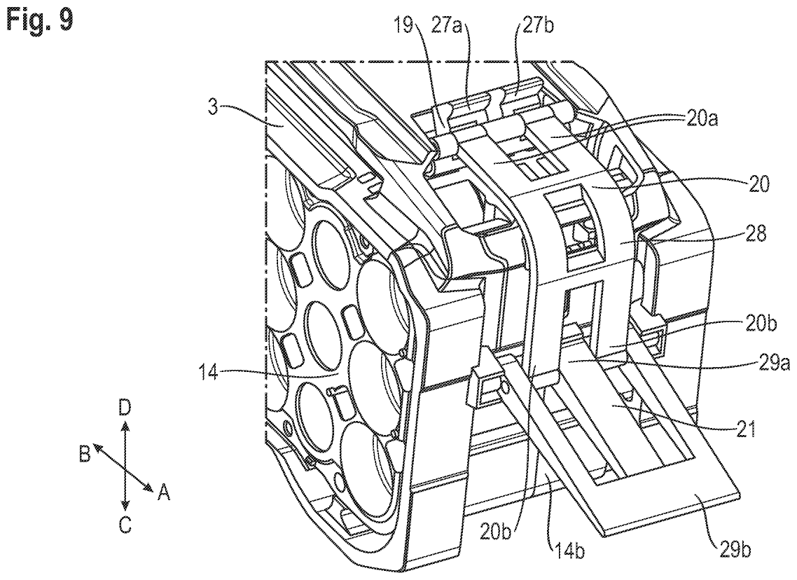

In FIGS. 8 and 9, the rechargeable battery 3 is illustrated with the locking apparatus 18 in a third position. The second end 29b of the third lever element 21 has been moved (i.e. pushed) a further distance downward in the arrow direction C. The first end 29a of the third lever element 21 rotates further about the pivot point of the third rotary joint 24 relative to the rear side 14b of the rechargeable battery housing 14. The first end 20a of the second lever element 20 is moved further in the arrow direction A and at the same time, the second end 20b of the second lever element 20 is moved further in the arrow direction C. The first and second hook element 27a, 27b are moved further in the arrow direction D as a result of the rotary movement of the first lever element 19 and engage further in the two recesses 10a, 10b of the rechargeable battery interface 8 of the power tool 2. The rechargeable battery 3 is moved in the arrow direction B by the movement of the locking apparatus 18, such that the elastic stop element 17 is compressed further between the rechargeable battery 3 and the power tool 2. The elastic stop element 17 presses on the rechargeable battery 3 with a greater spring force.

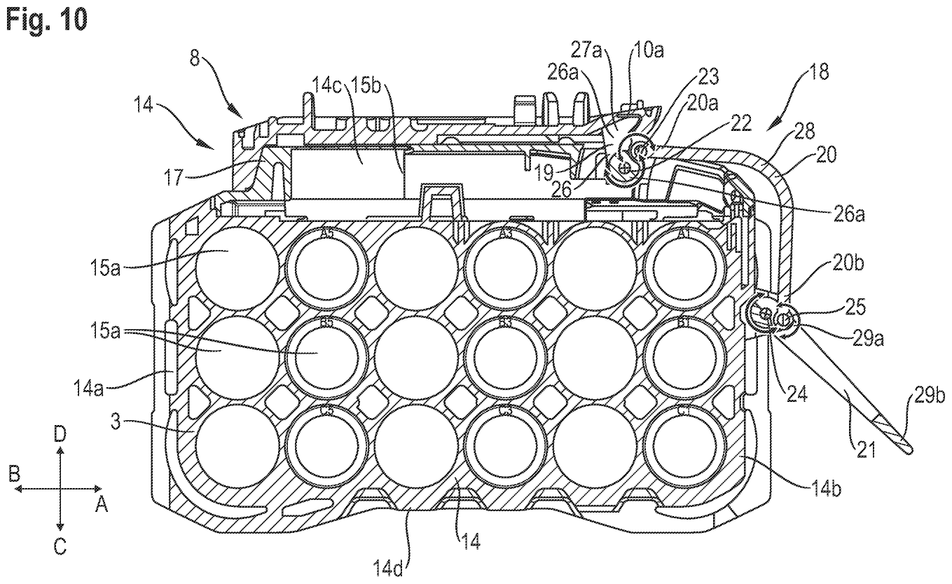

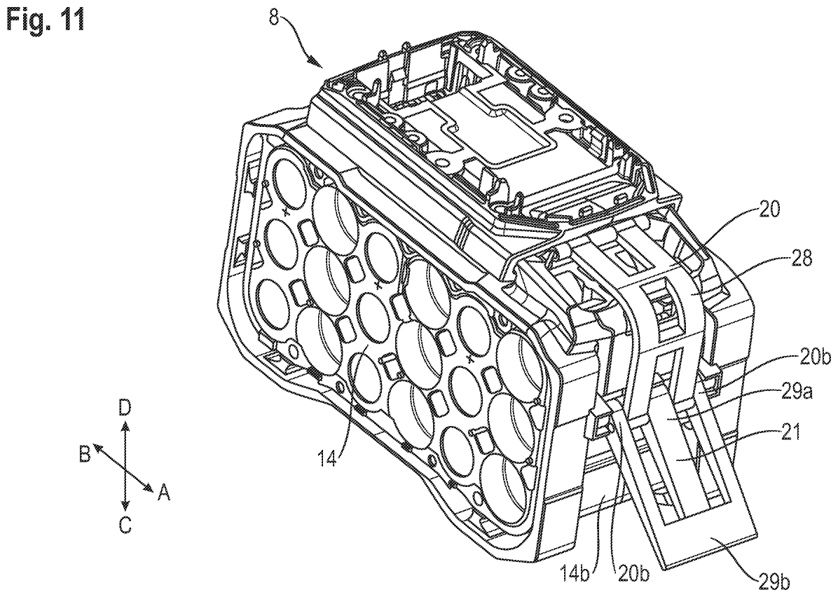

In FIGS. 10 and 11, the rechargeable battery 3 is illustrated with the locking apparatus 18 in a fourth position. The second end 29b of the third lever element 21 has been moved (i.e. pushed) a further distance downward in the arrow direction C. The first end 29a of the third lever element 21 rotates further about the pivot point of the third rotary joint 24 relative to the rear side 14b of the rechargeable battery housing 14. The first end 20a of the second lever element 20 is moved further in the arrow direction A and at the same time, the second end 20b of the second lever element 20 is moved further in the arrow direction C. The first and second hook element 27a, 27b are moved further in the arrow direction D as a result of the rotary movement of the first lever element 19 and engage further in the two recesses 10a, 10b of the rechargeable battery interface 8 of the power tool 2. The rechargeable battery 3 is moved in the arrow direction B by the movement of the locking apparatus 18, such that the elastic stop element 17 is compressed further between the rechargeable battery 3 and the power tool 2. The elastic stop element 17 presses on the rechargeable battery 3 with a greater spring force.

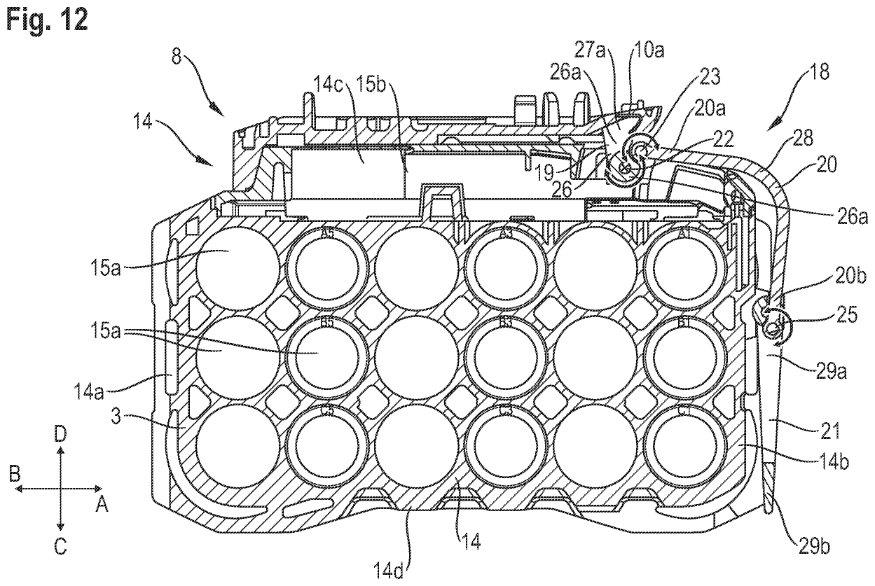

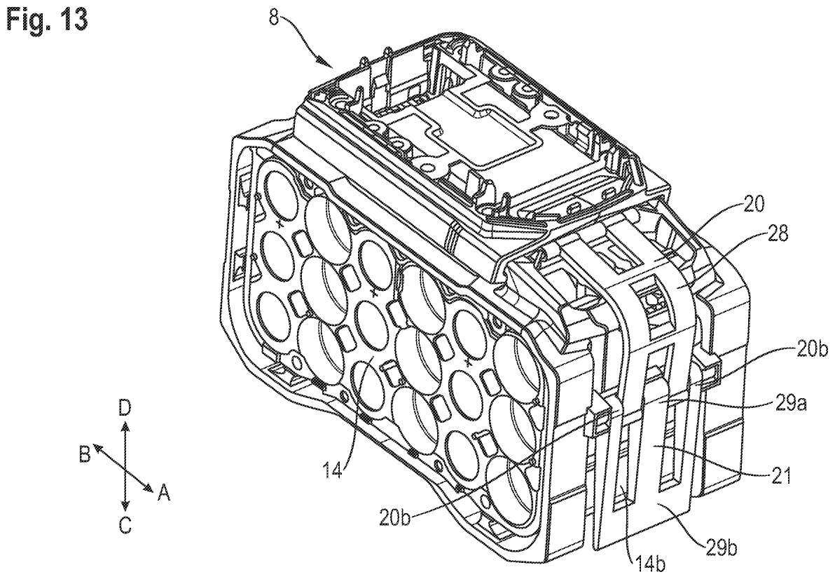

In FIGS. 12 and 13, the rechargeable battery 3 is illustrated with the locking apparatus 18 in a fifth or end position. The second end 29b of the third lever element 21 has been moved (i.e. pushed) a further distance downward in the arrow direction C, such that the third lever element 21 bears flat against the rear side 14b of the rechargeable battery housing 14. The first end 20a of the second lever element 20 is moved further in the arrow direction A and at the same time, the second end 20b of the second lever element 20 is moved further in the arrow direction C. The first and second hook element 27a, 27b are moved further in the arrow direction D as a result of the rotary movement of the first lever element 19 and now engage fully in the two recesses 10a, 10b of the rechargeable battery interface 8 of the power tool 2. The rechargeable battery 3 has now been moved as far as possible in the arrow direction B by the movement of the locking apparatus 18. The elastic stop element 17 is now compressed fully between the rechargeable battery 3 and the power tool 2. The elastic stop element 17 presses on the rechargeable battery 3 with a maximum spring force in the arrow direction A.

The rechargeable battery 3 is now fully and firmly connected to the power tool 2.

According to an alternative embodiment of the locking apparatus 18, it may also be possible for the locking apparatus 18 to be configured without the second and fourth rotary joints 23, 25.

### LIST OF REFERENCE SIGNS

1 System
2 Power tool
3 Rechargeable battery
4 Housing of the power tool
4a Front end of the housing of the power tool
4b Rear end of the housing of the power tool
4c Top side of the housing of the power tool
4d Underside of the housing of the power tool
5 Tool fitting
6 Main handle
7 Auxiliary handle
8 Rechargeable battery interface
9 Slot
10a First recess
10b Second recess
11 Rail
12 Plug
13 Socket
14 Rechargeable battery housing
14a Front side of the rechargeable battery housing
14b Rear side of the rechargeable battery housing
14c Top side of the rechargeable battery housing
14d Underside of the rechargeable battery housing
15a Energy storage cells
15b Control device
16 Power tool interface
17 Stop element
18 Locking apparatus
19 First lever element
20 Second lever element
20a First end of the second lever element
20b Second end of the second lever element
21 Third lever element
22 First rotary joint
23 Second rotary joint
24 Third rotary joint
25 Fourth rotary joint
26 Elongate basic body of the first lever element
26a First end of the elongate basic body
26b Second end of the elongate basic body
27a Second hook element
27b Second hook element
28 Curved basic body of the second lever element
29a First end of the third lever element
29b Second end of the third lever element

1-6. (canceled)

7. A system comprising:
a power tool; and
a rechargeable battery for supplying the power tool with electrical energy, the rechargeable battery including a lock for releasably connecting the rechargeable battery to the power tool, the lock including a first lever and a second lever connected together in an articulated manner, such that the lock is reversibly movable from a locking position into a releasing position, wherein, in the locking position, the rechargeable battery is firmly connected to the power tool and, in the releasing position, the rechargeable battery is removable from the power tool.

8. The system as recited in claim 7 further comprising a third lever for reversibly actuating the second lever from a first position into a second position.

9. The system as recited in claim 7 wherein the second lever is configured at least partially in an elastic manner.

10. The system as recited in claim 7 wherein the lock is configured as a toggle mechanism.

11. The system as recited in claim 7 further comprising at least one elastic stop between the rechargeable battery and power too, the at least one elastic stop being positioned opposite the lock.

12. A rechargeable battery for supplying a power tool with electrical energy, the rechargeable battery comprising a lock for releasably connecting the rechargeable battery to the power tool, the lock including a first lever and a second lever connected together in an articulated manner, such that the lock is reversibly movable from a locking position into a releasing position, wherein, in the locking position, the rechargeable battery is firmly connected to the power tool and, in the releasing position, the rechargeable battery is removable from the power tool.
